(19) United States
(12) Patent Application Publication
(10) Pub. No.: US 2012/0015079 A1
(43) Pub. Date: Jan. 19, 2012

(54) STUFFED RICE FOOD PRODUCT AND PRODUCTION METHOD THEREOF

(76) Inventors: Kazuhiro Watanabe, Tokyo (JP); Shozo Kudo, Tokyo (JP)

(21) Appl. No.: 13/259,324

(22) PCT Filed: Jan. 22, 2010
(86) PCT No.: PCT/JP2010/050810

§ 371 Date: Sep. 23, 2011

(30) Foreign Application Priority Data
Apr. 10, 2009 (JP) 2009-095391

(51) Int. Cl. A23L 1/10; A23P 1/08

(52) U.S. Cl. 426/93; 426/273

(57) ABSTRACT

The present invention provides a rice food product stuffed with a filling ingredient, which is prevented from leaking out of a rice portion even if it is a fluid filling ingredient. A stuffed rice ball (1) according to the present invention includes a filling ingredient (2), a half-mashed rice portion (3) which encloses the filling ingredient (2), and a non-mashed rice portion (4) which encloses the half-mashed rice portion. The filling ingredient (2) may be primarily enclosed with a first half-mashed rice portion (3), which is further enclosed with a second half-mashed rice portion (3). The second half-mashed rice portion is further enclosed with a non-mashed rice portion (4). As a result, a rice ball can be provided, which is properly stuffed with a fluid filling ingredient, and has an excellent rice texture.

### TECHNICAL FIELD

The present invention relates to a stuffed rice food product, i.e., a rice ball-like food product stuffed with a filling ingredient, and to a production method thereof. Particularly, the invention relates to a rice food product properly stuffed with a fluid filling ingredient such as curry or an half-boiled egg.

### BACKGROUND ART

Conventionally, filling ingredients for rice balls are limited to solid filling ingredients. This is because fluid filling ingredients are liable to leak through gaps between cooked rice grains to significantly impair their product values.

Patent Literature 1 proposes a rice food product including a cooked food item enclosed with a glutinous rice paste. The rice food product proposed in Patent Literature 1 is a glutinous rice cake stuffed with the cooked food item, and a highly viscous and extensible glutinous rice paste or rice dumpling dough is used for enclosing the cooked food item.

Patent Literature 2 proposes a curry rice ball. The curry rice ball proposed in Patent Literature 2 is produced by enclosing a frozen curry lump with an oblate and making a rice ball with the enclosed frozen curry lump positioned at the center thereof.

### Citation List

### Patent Literature

Patent Literature 1: JP-U-SHO63(1988)-53286

Patent Literature 2: JP-HEI4(1992)-99455

### SUMMARY OF INVENTION

### Technical Problem

In the rice food product disclosed in Patent Literature 1, the glutinous rice paste or the rice dumpling dough, which is used as a wrapper for enclosing the filling ingredient, is quite different in texture from the rice of the rice ball. For a person who wants to eat a rice ball, therefore, the rice food product disclosed in Patent Literature 1 is far from the rice ball.

It is stated in Patent Literature 2 that a person who eats the curry rice ball will not have an odd feeling because the oblate used in the curry rice ball is made of food starch. However, the curry rice ball still has room for improvement in the texture of the oblate.

In view of the foregoing, it is a principal object of the present invention to provide a rice food product stuffed with a filling ingredient, which is prevented from leaking out of a rice portion even if it is a fluid filling ingredient.

It is another object of the present invention to provide a readily-edible rice food product stuffed with a fluid filling ingredient and having excellent texture.

It is further another object of the present invention to provide a method of producing a rice food product stuffed with a fluid filling ingredient.

### Solution to Problem

According to claim 1 of the present invention to solve the aforementioned problem, there is provided a stuffed rice food product, which includes a filling ingredient, a half-mashed rice portion which encloses the filling ingredient, and a non-mashed rice portion which encloses the half-mashed rice portion.

According to claim 3, when the filling ingredient is enclosed with the half-mashed rice portion, the filling ingredient is primarily enclosed with a first half-mashed rice portion, which is further enclosed with a second half-mashed rice portion, and the second half-mashed rice portion is further enclosed with the non-mashed rice portion.

When the stuffed rice food product is produced, polished rice is preliminarily divided into two or three portions, which are cooked in this state. Thus, the non-mashed rice portion has an excellent grain texture for the enclosing.

The filling ingredient may include a food ingredient and 10 to 90% of cooked rice preliminarily mixed together (claim 2 or 4). This arrangement imparts the filling ingredient with a rice texture, while permitting use of a fluid food ingredient.

According to claim 5 of the present invention, there is provided a stuffed rice food production method, which includes the steps of: cooking rice to prepare cooked rice; preparing a filling ingredient in parallel with the rice cooking step; preparing half-mashed rice from a part of the cooked rice, and enclosing the filling ingredient with the half-mashed rice; further enclosing the resulting half-mashed rice portion with a non-mashed portion of the cooked rice; packaging the resulting stuffed rice food product which includes the filling ingredient enclosed doubly with the half-mashed rice portion and the non-mashed rice portion; and quickly freezing the packaged stuffed rice food product.

When the filling ingredient is enclosed with the half-mashed rice in the production method, the half-mashed rice desirably has a temperature of not lower than 30° C. If the temperature of the half-mashed rice is lower, the half-mashed rice has a lower viscosity, failing to properly enclose the filling ingredient.

A fluid food ingredient such as a half-boiled egg, curry or Sichuan style bean curd may be used as the filling ingredient. The fluid food ingredient may be used alone as the filling ingredient, or may be mixed with 10 to 90% of the cooked rice to provide the filling ingredient. By thus mixing the food ingredient with the cooked rice, it is possible to impart the filling ingredient with the rice texture, while adjusting the fluidity of the filling ingredient. Thus, the filling ingredient can be further properly enclosed.

It is preferred to quickly freeze the packaged stuffed rice food product at about −35° C. The quickly frozen stuffed rice food product can be unfrozen by means of a microwave oven to be thereby quickly and tastily cooked.

The stuffed rice food product may be stored or delivered in a chilled state without the quick freezing.

### Advantageous Effects of Invention

According to the present invention, a rice ball (stuffed rice food product) can be provided, which is properly stuffed with a fluid filling ingredient, and has an excellent rice texture.

For example, the inventive stuffed rice food product is put in a bowl and unfrozen in an microwave oven. When the peripheral rice portions are broken with chopsticks, the inside food (filling) ingredient flows out. Thus, the inventive stuffed rice food product has a novel taste. Where the stuffed rice food product includes a half-boiled egg as the filling ingredient, for example, the stuffed rice food product is put in a bowl and unfrozen and, when the rice portions are broken with chopsticks, the inside half-boiled egg flows out. Thus, the stuffed rice food product has a novel taste like a raw egg rice.

### BRIEF DESCRIPTION OF THE DRAWINGS

FIG. 1 is a schematic perspective view of a stuffed rice ball as a stuffed rice food product according to one embodiment of the present invention.

FIG. 2 is a flow diagram for explaining steps of a stuffed rice food production method.

### DESCRIPTION OF EMBODIMENTS

Specific embodiments of the present invention will hereinafter be described with reference to the attached drawings.

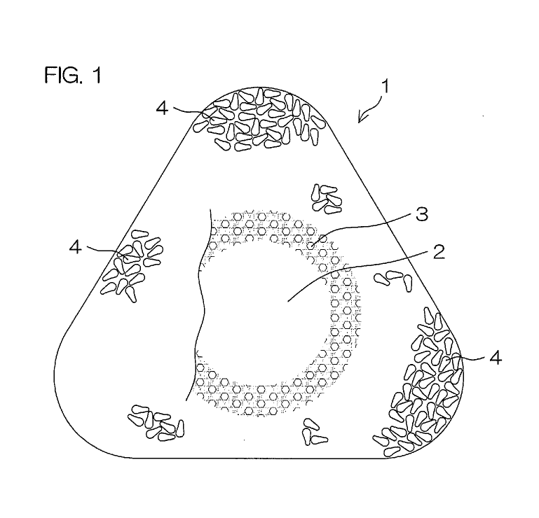

FIG. 1 is a schematic perspective view illustrating a stuffed rice ball as a stuffed rice food product according to one embodiment of the present invention partly in section for easy view of the inside.

The stuffed rice ball 1 includes a fluid filling ingredient such as a half-boiled egg, curry or Sichuan style bean curd confined in its center portion 2. The center portion 2 or the filling ingredient is enclosed with a half-mashed rice portion 3. The half-mashed rice portion is made of viscous rice, as implied by its name, which is prepared by moderately kneading cooked rice by means of a feed mechanism (kneader) provided in an enclosing machine, and is capable of enclosing even the fluid filling ingredient without leakage.

In the rice ball 1 according to this embodiment, the center portion 2 or the filling ingredient is enclosed with the half-mashed rice portion 3, and the half-mashed rice portion 3 is further enclosed with a non-mashed rice portion 4, which is formed in a rice ball shape.

The outer shape of the stuffed rice ball 1 may be a triangular shape as shown in FIG. 1, a round shape, a barrel shape, or any other shape.

The filling ingredient in the center portion 2 may be any of various food ingredients. Where a highly fluid food ingredient (e.g., a liquid-like food ingredient such as soup) is used as the filling ingredient, the food ingredient may be preliminarily mixed with 10 to 90% of cooked rice. This makes it possible to impart the center portion 2 with a rice texture, while enclosing the highly fluid food ingredient.

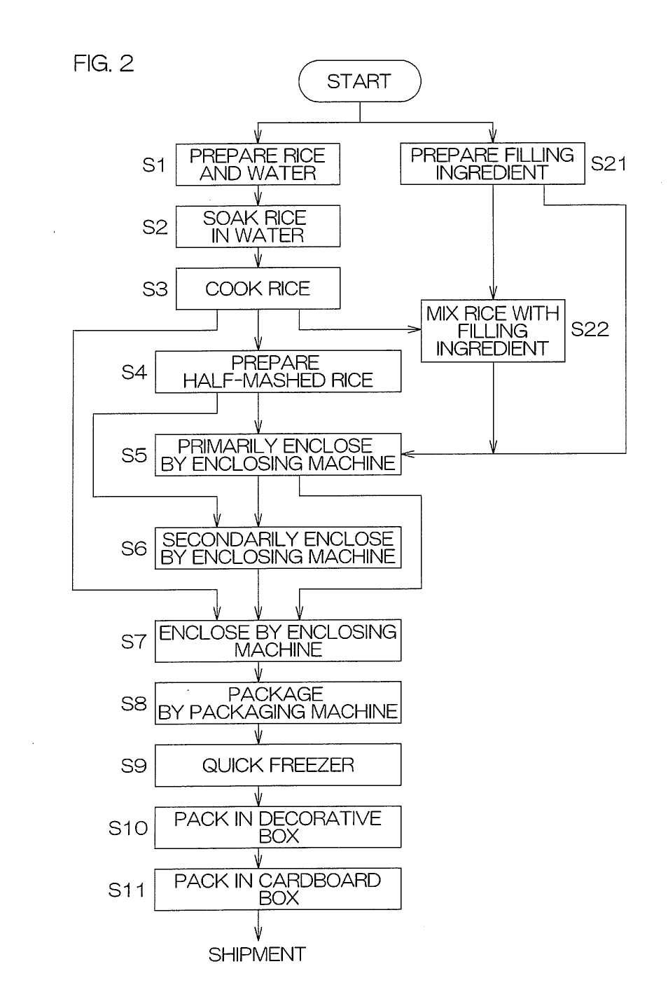

FIG. 2 is a flow diagram for explaining steps of a stuffed rice food production method.

Referring to FIG. 2, the stuffed rice food production method will be described according to another embodiment of the present invention.

First, rice and water are prepared (Step S1), and the rice is soaked in the water (Step S2). After the rice sufficiently absorbs the water, the rice is cooked (Step S3).

In parallel with the rice cooking step, a filling ingredient is prepared (Step S21). A fluid food ingredient may be used as the filling ingredient.

Where a highly fluid food ingredient is used as the filling ingredient, the food ingredient may be preliminarily mixed with a part of the rice cooked in Step S3 (Step S22).

Half-mashed rice is prepared from another part of the rice cooked in Step S3 (Step S4). The half-mashed rice may be prepared in a specific half-mashed rice preparing step, or may be prepared by moderately kneading a part of the cooked rice by means of a feed mechanism (kneader) when the cooked rice is fed into the enclosing machine.

In this embodiment, the filling ingredient is primarily enclosed with the half-mashed rice prepared in Step S4 (Step S5). The enclosing step is automatically performed by the enclosing machine.

In the production method, the step of primarily enclosing the filling ingredient with the half-mashed rice by the enclosing machine may be followed by the step of secondarily enclosing the resulting enclosed food product with the half-mashed rice (Step S6). The method involving the primary enclosing of the filling ingredient with the half-mashed rice and the secondary enclosing of the resulting enclosed food product with the half-mashed rice reliably prevents the filling ingredient from leaking out of the center portion 2 even if a highly fluid food ingredient is used as the filling ingredient.

When the primary enclosing step or the secondary enclosing step is performed by employing the half-mashed rice in Step S5 or Step S6, the temperature of the half-mashed rice is desirably not lower than 30° C. If the temperature of the half-mashed rice is lower than this temperature, the half-mashed rice has a lower viscosity, failing to properly enclose the fluid filling ingredient.

The food product resulting from the primary enclosing or the secondary enclosing with the half-mashed rice is further enclosed with a non-mashed portion of the rice cooked in Step S3. That is, the food product is further enclosed with the non-mashed rice with the use of the enclosing machine (Step S7). Thus, the stuffed rice ball 1 shown in FIG. 1 is produced.

The stuffed rice ball 1 thus produced is packaged by an automatic packaging machine (Step S8). The stuffed rice ball thus packaged is quickly frozen, for example, at a temperature of −35° C. (Step S9). Then, a plurality of such packaged rice balls are respectively packed in decorative boxes (Step S10), which are packed in a cardboard box (Step S11) and shipped.

The stuffed rice food product produced in the aforementioned manner is frozen and, therefore, can be stored for a long period of time. When the stuffed rice food product is to be eaten, the rice food product is unfrozen in a microwave oven to be thereby quickly and tastily cooked. For example, a rice food product stuffed with an egg is unpacked, put in a bowl, and unfrozen in the microwave oven to be thereby provided in a hot state. Then, the rice food product is broken into with chopsticks, and a soy sauce or the like is added dropwise onto the rice food product. Thus, tasty egg rice can be readily provided.

The present invention is not limited to the embodiments described above, but various modifications may be made within the scope of the present invention defined by the appended claims.

### REFERENCE SIGNS LIST

1: Stuffed rice ball
2: Center portion (filling ingredient or food ingredient)
3: Half-mashed rice
4: Non-mashed rice

What is claimed is:

1. A stuffed rice food product comprising:
a filling ingredient;
a half-mashed rice portion which encloses the filling ingredient; and
a non-mashed rice portion which encloses the half-mashed rice portion.

2. The stuffed rice food product according to claim 1, wherein the filling ingredient includes a food ingredient and 10 to 90% of cooked rice preliminarily mixed together.

3. A stuffed rice food product comprising:
a filling ingredient;
a first half-mashed rice portion which primarily encloses the filling ingredient;
a second half-mashed rice portion which further encloses the first half-mashed rice portion; and
a non-mashed rice portion which encloses the second half-mashed rice portion.

4. The stuffed rice food product according to claim 3, wherein the filling ingredient includes a food ingredient and 10 to 90% of cooked rice preliminarily mixed together.

5. A stuffed rice food production method comprising the steps of:
cooking rice to prepare cooked rice;
preparing a filling ingredient in parallel with the rice cooking step;
preparing half-mashed rice from a part of the cooked rice, and enclosing the filling ingredient with the half-mashed rice;
further enclosing the resulting half-mashed rice portion with a non-mashed portion of the cooked rice;
packaging the resulting stuffed rice food product which includes the filling ingredient enclosed doubly with the half-mashed rice portion and the non-mashed rice portion; and
quickly freezing the packaged stuffed rice food product.
